(19) United States
(12) Patent Application Publication
(10) Pub. No.: US 2016/0261025 A1
(43) Pub. Date: Sep. 8, 2016

(54) ELECTRONIC DEVICE WITH MINIATURE MULTIPLE ANTENNAS

(71) Applicants: HONG FU JIN PRECISION INDUSTRY (ShenZhen) Co., Ltd, Shenzhen (CN); HON HAI PRECISION INDUSTRY CO., LTD., New Taipei (TW)

(72) Inventors: HSIEN-PEI LUNG, New Taipei (TW); WU-ZHE YU, Shenzhen (CN)

(21) Appl. No.: 14/737,767

(22) Filed: Jun. 12, 2015

(30) Foreign Application Priority Data
Mar. 4, 2015 (CN) 201510095852.8

(51) Int. Cl. H01Q 1/24; H01Q 21/00

(52) U.S. Cl. CPC H01Q 1/243; H01Q 21/00

(57) ABSTRACT

An electronic device includes a shell and at least two antennas. Each corner of the shell is formed between two adjacent side walls. The antennas are set in opposing corners, and a shape of each antenna adapts to a shape of the corner. An angle of radiation of the antenna in front or behind the shell can be enlarged to increase the effectiveness of receiving or transmitting signals of the antenna.

### FIELD

The subject matter herein generally relates to an electronic device.

### BACKGROUND

An antenna is usually set on an outside of a side wall of a mini personal computer (PC), and occupies space of the outer side walls, using space which could be used for more ports and interfaces.

### BRIEF DESCRIPTION OF THE DRAWINGS

Implementations of the present technology will now be described, by way of example only, with reference to the attached figures.

FIG. 1 is a perspective view of an electronic device.

FIG. 2 is an isometric view of a first embodiment of the electronic device of FIG. 1.

FIG. 3 is an isometric view of a second embodiment of the electronic device of FIG. 1.

FIG. 4 is a cross sectional view of an antenna of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like.

The disclosure will now be described in relation to an electronic device.

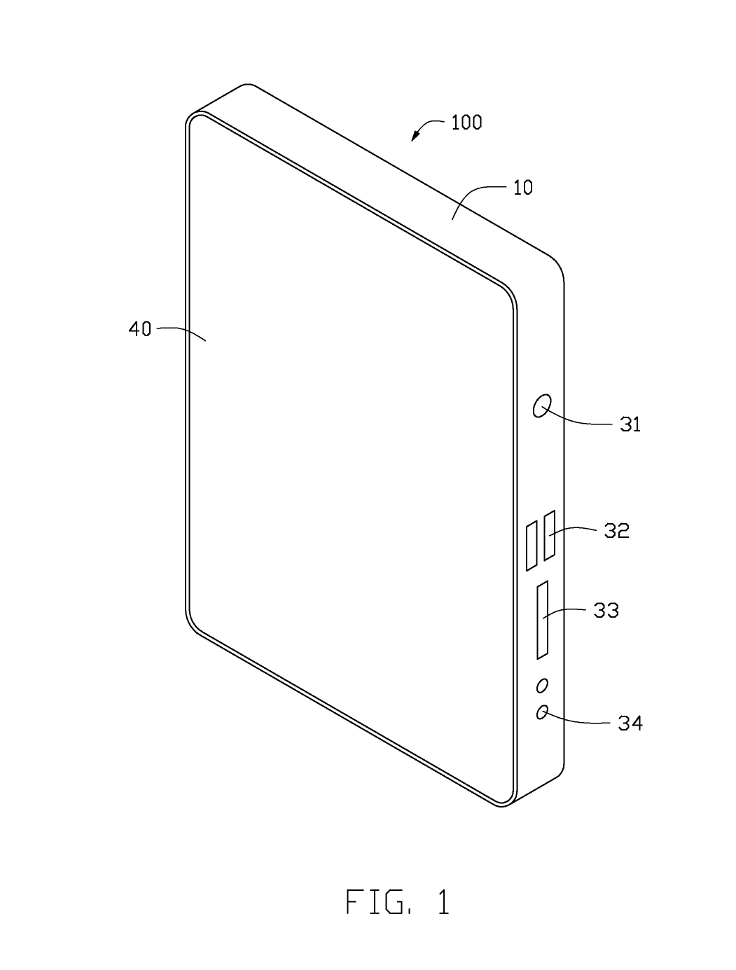

FIG. 1 illustrates an electronic device 100. The electronic device 100 includes a shell 10 and a cover 40.

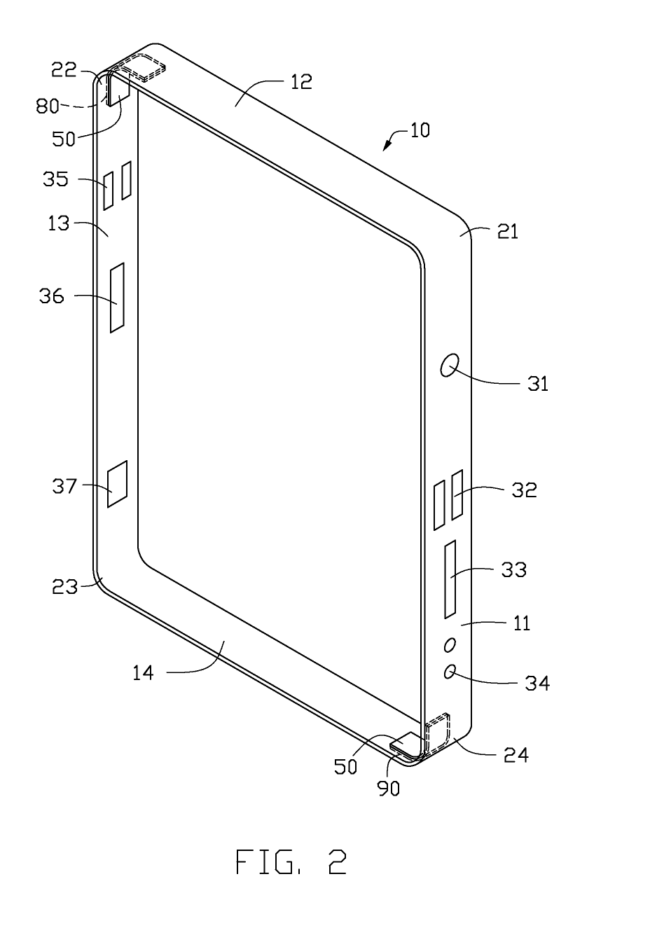

FIG. 2 illustrates a first embodiment of the electronic device 100. The shell 10 includes first to fourth side walls 11, 12, 13, and 14. A first corner 21 is formed between the first side wall 11 and the second side wall 12. A second corner 22 is formed between the second side wall 12 and the third side wall 13. A third corner 23 is formed between the third side wall 13 and the fourth side wall 14. A fourth corner 24 is formed between the fourth side wall 14 and the first side wall 11. A switch 31, two USB interfaces 32, a card reader interface 33, and an audio interface 34 are formed on the first side wall 11. Two USB interfaces 35, a multimedia interface 36, and a network interface 37 are formed on the third side wall 13. The number of the interfaces on the first side wall 11 and the third side wall 13 said before can be according to an actual requirement.

The electronic device 100 further includes at least two embedded antennas 50. In at least one embodiment, the number of the embedded antennas 50 is two. An embedded antenna 50 is installed on inner surface of the second corner 22 and on inner surface of the fourth corner 24. A shape of each antenna 50 matches a shape of the inner surface of the corner. When the antennas 50 are installed on the inner surfaces of the second and fourth corners 22 and 24, an angle of radiation of the antenna 50 on the second corner 22 is such that radiated electromagnetic waves can propagate throughout an area of a positive hemisphere above the second corner 22 of the shell 10, and an angle of radiation of the antenna 50 on the fourth corner 24 allows the same propagation in an area of a negative hemisphere below the fourth corner 24 of the shell 10. Therefore, an effectiveness of receiving or transmitting signals of the antenna 50 can be improved.

In at least one embodiment, a first groove 80 and a second groove 90 are respectively etched on the inner surfaces of the second corner 22 and the fourth corner 24, for receiving the two antennas 50.

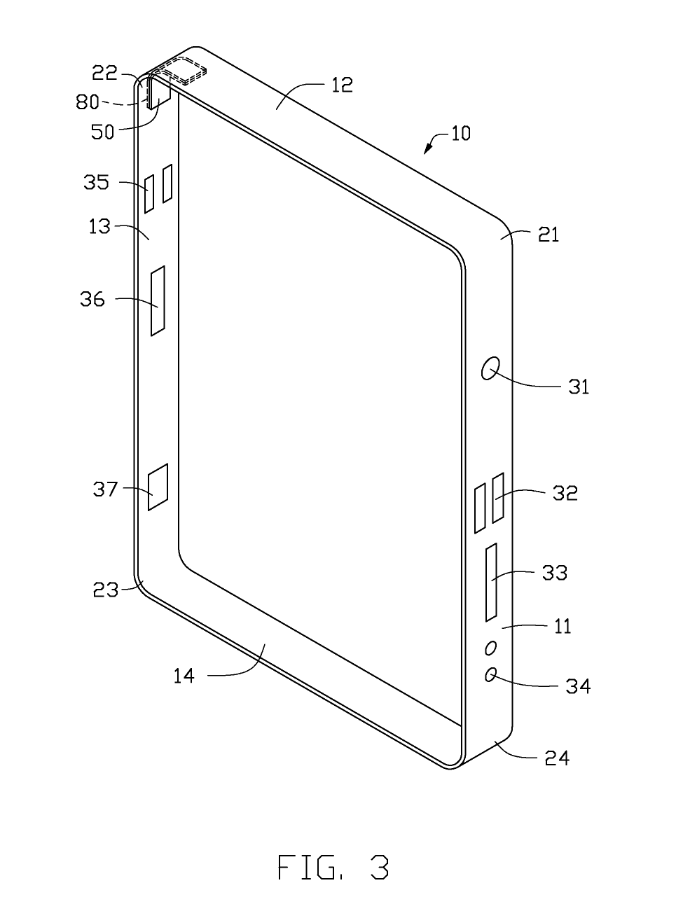

FIG. 3 illustrates a second embodiment of the electronic device 100. A difference between the first embodiment and the second embodiment is that, in the second embodiment, the electronic device 100 includes only one antenna 50. A shape of the antenna 50 matches each of first to fourth corners 22, 23, 24, and 25, and is set on the inner surface of the second corner 22. In at least one embodiment, a groove 80 is etched on the inner surface of the second corner 22 for receiving the antenna 50. In other embodiments, the number of antennas 50 can be according to the actual requirement.

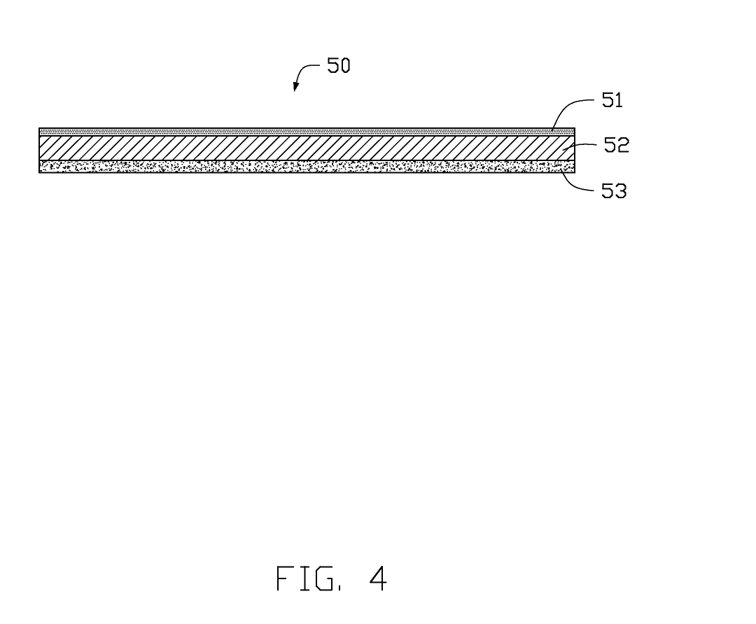

FIG. 4 is a sectional view of an antenna 50 of the electronic device 100. The antenna 50 includes a first layer 51, a second layer 52 coupled to the first layer 51, and a third layer 53 coupled to the second layer 52. In at least one embodiment, the first layer 51 is made of adhesive paper, to attach the second layer 52 on a corner of the shell 10. A material of the second layer 52 is metal such as thin copper. The third layer 53 is a thermostable gummed paper to function as antioxidant and antistatic.

As detailed above, each antenna 50 is flexible and installed on an inner surface of a corner. Therefore, an area of the antenna 50 can be enlarged, to enlarge an angle of radiation of the antenna 50, and to improve the effectiveness of the receiving or transmitting signals of the antenna 50. More interfaces or functioning units can be installed on the side walls 11, 12, 13, and 14.

While the disclosure has been described by way of example and in terms of the embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An electronic device comprising:
a shell comprising a plurality of side walls;
a plurality of corners formed between two adjacent side walls; and
at least two antennas and a shape of each antenna matching to a shape of the inner surface of the corresponding corner;
wherein the at least two antennas are installed on inner surfaces of the corners.

2. The electronic device of claim 1, wherein the first and second antennas are respectively installed on the inner surface of the corners distributed diagonally on the shell.

3. The electronic device of claim 2, wherein the shell comprises first to fourth side walls, the first antenna is installed on an inner surface of the corner between the second side wall and the third side wall of the shell, and the second antenna is installed on an inner surface of the corner between the fourth side wall and the first side wall.

4. The electronic device of claim 3, further comprising a first groove and a second groove, the first groove is etched on the inner surface of the corner between the second side wall and the third side wall of the shell, the second groove is etched on the inner surface of the corner between the fourth side wall and the first side wall, the first and second antennas are installed in the first and second grooves respectively.

5. The electronic device of claim 4, wherein each of the antennas comprises a first layer, a second layer composed of metal and coupled to the first layer, and a third layer functions as antioxidant and antistatic and is coupled to the second layer, the first layer attaches the second layer to the corresponding corner of the shell.

6. The electronic device of claim 5, wherein the first layer is a sticky gummed paper, the second layer is a copper foil, and the third layer is a thermostability gummed paper.

7. An electronic device comprising:
a shell comprising a plurality of side walls; wherein a plurality of corners are formed between two adjacent side walls; and
an antenna installed on an inner surface of one corresponding corner of the shell;
wherein a shape of the antenna corresponds to a shape of the inner surface of the corresponding corner.

8. The electronic device of claim 7, wherein the shell comprises first to fourth side walls, the antenna is installed on the inner surface of the corner between the second side wall and the third side wall of the shell.

9. The electronic device of claim 8, wherein the shell further comprises a groove, the groove is etched on the inner surface of the corner between the second side wall and the third side wall of the shell, the antenna is configured to install in the groove in cooperation.

10. The electronic device of claim 9, wherein each of the antennas comprises a first layer, a second layer composed of metal and coupled to the first layer, and a third layer functions as antioxidant and antistatic and is coupled to the second layer, the first layer attaches the second layer to the corresponding corner of the shell.

11. The electronic device of claim 10, wherein the first layer is a sticky gummed paper, the second layer is a copper foil, and the third layer is a thermostability gummed paper.

12. The electronic device of claim 11, further comprising a plurality of interfaces on the first and third side wall of the shells.
